(19) United States
(12) Patent Application Publication
(10) Pub. No.: US 2015/0143283 A1
(43) Pub. Date: May 21, 2015

(54) INFORMATION PROCESSING DEVICE, DISPLAY CONTROL METHOD, AND PROGRAM

(71) Applicant: SONY CORPORATION, Tokyo (JP)

(72) Inventors: Takuro Noda, Tokyo (JP); Kazuyuki Yamamoto, Kanagawa (JP); Kenji Suzuki, Tokyo (JP); Tetsuyuki Miyawaki, Tokyo (JP)

(73) Assignee: SONY CORPORATION, Tokyo (JP)

(21) Appl. No.: 14/407,746

(22) PCT Filed: Aug. 20, 2013
(86) PCT No.: PCT/JP2013/004917

§ 371 Date: Dec. 12, 2014

(30) Foreign Application Priority Data
Oct. 1, 2012 (JP) 2012-219451

(51) Int. Cl. G06F 3/0485; G02B 27/01; G06F 3/0488

(52) U.S. Cl. CPC G06F 3/0485; G06F 3/04883; G02B 27/017; G02B 2027/0178
USPC 715/784

(57) ABSTRACT

An apparatus includes a display control circuit configured to control a display to display content; and a user input circuit configured to receive a command from the user. The display control circuit is configured to modify scrolling of the content being automatically scrolled in a first direction based on the command from the user.

### TECHNICAL FIELD

The present disclosure relates to an information processing device, a display control method, and a program encoded on a non-transitory computer readable medium.

The present disclosure contains subject matter related to that disclosed in Japanese Priority Patent Application JP 2012-219451 filed in the Japan Patent Office on Oct. 1, 2012, the entire content of which is hereby incorporated by reference.

### BACKGROUND ART

Recently, the amount of information provided to users by information devices is becoming enormous as a result of developments in information technology. Additionally, users are spending more time in contact with information. For example, PTL 1 below discloses technology that displays a user's biological information on a head-mounted display (HMD) screen for purposes such as healthcare. With the technology disclosed by PTL 1 below, messages related to a user's biological information may be scrolled on-screen. Messages are displayed even while a user is performing exercise such as jogging.

### CITATION LIST

### Patent Literature

PTL 1: JP 2008-99834A

### SUMMARY

### Technical Problem

However, in the case of providing information via an ordinary information device, a user activates a screen when he or she wants to ascertain information. In contrast, in the case of providing information via a wearable device such as an HMD, a screen is continuously running irrespective of whether the user is actively viewing the screen. In addition, various information may be displayed on-screen even while the user is performing any given activity. For this reason, in the case of providing information via a wearable device, there is a high likelihood that the times when the user wants to ascertain information will be out of synchronization with the times when information of interest to the user is displayed.

Consequently, it is desirable to provide a mechanism that resolves such asynchronous timings and enables a user to efficiently acquire information.

### Solution to Problem

The present invention broadly comprises an apparatus, a method, and a program encoded on a non-transitory computer readable medium. In one embodiment, the apparatus includes a display control circuit configured to control a display to display content; and a user input circuit configured to receive a command from the user. The display control circuit is configured to modify scrolling of content being automatically scrolled in a first direction based on the command from the user.

### Advantageous Effects of Invention

According to technology in accordance with the present disclosure, in the case of providing information via a wearable device, it becomes possible for a user to efficiently acquire information that he or she is interested in at the times when he or she wants to ascertain information.

### BRIEF DESCRIPTION OF DRAWINGS

FIG. 1 is an explanatory diagram illustrating an example of the exterior of an information processing device.

FIG. 2A is a first explanatory diagram for explaining a first example of a scrolling item.

FIG. 2B is a second explanatory diagram for explaining a first example of a scrolling item.

FIG. 3 is an explanatory diagram for explaining a second example of a scrolling item.

FIG. 4 is an explanatory diagram for explaining a third example of a scrolling item.

FIG. 5 is a block diagram illustrating an example of a hardware configuration of an information processing device according to an embodiment.

FIG. 6 is a block diagram illustrating an example of a logical functional configuration of an information processing device according to an embodiment.

FIG. 7 is an explanatory diagram for explaining a first technique for detecting a user operation.

FIG. 8 is an explanatory diagram for explaining a second technique for detecting a user operation.

FIG. 9 is an explanatory diagram for explaining an example of rewinding the scroll position according to a user operation.

FIG. 10 is an explanatory diagram for explaining an example of fast-forwarding the scroll position according to a user operation.

FIG. 11 is an explanatory diagram for explaining another example of rewinding the scroll position according to a user operation.

FIG. 12 is a flowchart illustrating a first example of the flow of a display control process according to an embodiment.

FIG. 13 is a flowchart illustrating a second example of the flow of a display control process according to an embodiment.

FIG. 14A is a flowchart illustrating a first example of a detailed flow of an operation target selection process.

FIG. 14B is a flowchart illustrating a second example of a detailed flow of an operation target selection process.

FIG. 15 is an explanatory diagram for explaining the selection of an operation target item based on a gesture determination.

FIG. 16 is a first explanatory diagram for explaining additional display control according to a user operation.

FIG. 17 is a second explanatory diagram for explaining additional display control according to a user operation.

FIG. 18 is an explanatory diagram for explaining an example of linking an information processing device and an external device.

FIG. 19 is an explanatory diagram for explaining a third technique for detecting a user operation.

### DESCRIPTION OF EMBODIMENTS

It should be understood by those skilled in the art that various modifications, combinations, sub-combinations and alterations may occur depending on design requirements and other factors insofar as they are within the scope of the appended claims or the equivalents thereof.

Hereinafter, a preferred embodiment of the present disclosure will be described in detail and with reference to the attached drawings. Note that, in this specification and the appended drawings, structural elements that have substantially the same function and structure are denoted with the same reference numerals, and repeated explanation of these structural elements is omitted.

The description will proceed in the following order.

1. Overview

2. Configuration of device according to embodiment

2-1. Hardware configuration

2-2. Functional configuration

3. Process flows

3-1. Overall flow

3-2. Operation target selection process

3-3. Additional display control

4. Linking with external device

5. Conclusion

### 1. OVERVIEW

Technology according to the present disclosure is applicable to various forms of information processing device, a typical example of which is a wearable device such as a head-mounted display (HMD).

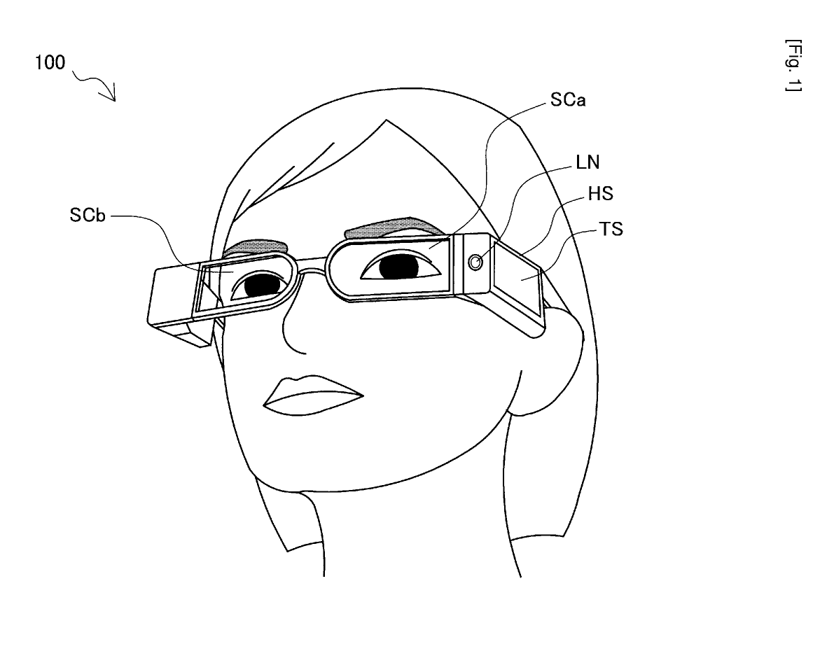

FIG. 1 is an explanatory diagram illustrating an example of the exterior of an information processing device to which technology according to the present disclosure may be applied. In the example in FIG. 1, the information processing device 100 is a glasses-style wearable device worn on a user's head. The information processing device 100 is equipped with a pair of screens SCa and SCb, a housing HS, an imaging lens LN, and a touch surface TS. The screens SCa and SCb are see-through or non-see-through screens arranged in front of the user's left eye and right eye, respectively. Note that instead of the screens SCa and SCb, a single screen arranged in front of both of the user's eyes may also be implemented. The housing HS includes a frame that supports the screens SCa and SCb, and what are called temples positioned on the sides of the user's head. Various modules for information processing are stored inside the temples. The imaging lens LN is arranged such that the optical axis is approximately parallel to the user's line of sight, and is used to capture images. The touch surface TS is a surface that detects touches by the user, and is used in order for the information processing device 100 to receive user operations. Instead of the touch surface TS, operating mechanism such as a button, switch, or wheel may also be installed on the housing HS.

As FIG. 1 demonstrates, the screens SCa and SCb of the information processing device 100 are continuously present in the user's visual field. In addition, various information may be displayed on the screens SCa and SCb, irrespective of what activity the user is performing. The information provided to the user may be information in text format, or information in graphical format. Information may automatically scroll on-screen in the case where the sizes of individual information items are not small. In this specification, an information item that automatically scrolls on-screen is designated a scrolling item.

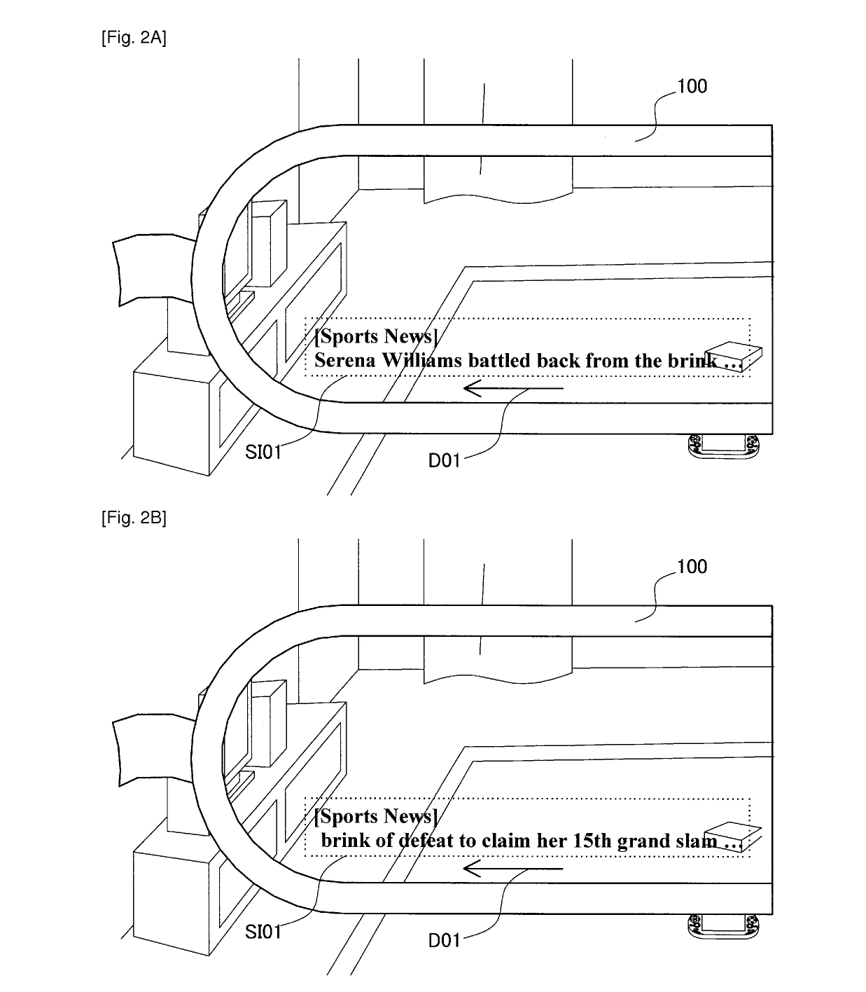

FIGS. 2A and 2B are explanatory diagrams for explaining a first example of a scrolling item. Referring to FIG. 2A, a scrolling item SI01 expressing information belonging to news information is being displayed on-screen in the information processing device 100. The display size of the scrolling item SI01 is not large enough to at once express the full content of the news. For this reason, the information processing device 100 automatically scrolls a string stating the news content in a scrolling direction D01 inside the scrolling item SI01. In FIG. 2A, the scrolling item SI01 is displaying the first half of the news content, whereas in FIG. 2B, the scrolling item SI01 is displaying the second half of the news content.

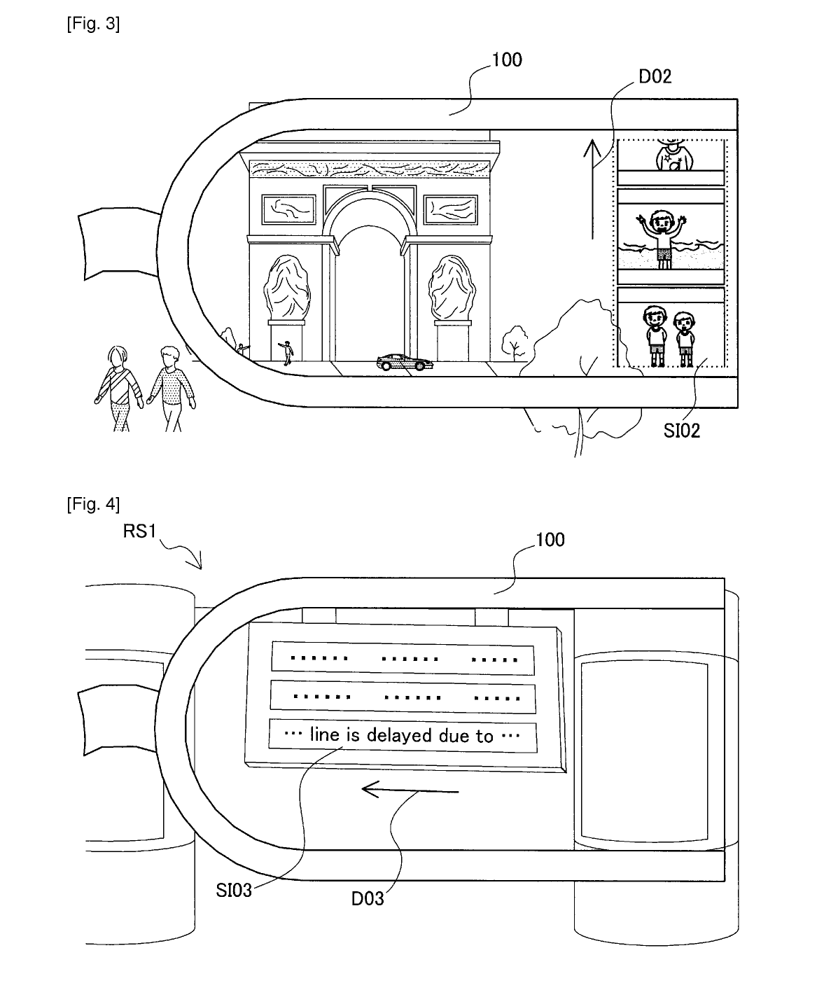

FIG. 3 is an explanatory diagram for explaining a second example of a scrolling item. Referring to FIG. 3, a scrolling item SI02 expressing image content is being displayed on-screen in the information processing device 100. The display size of the scrolling item SI02 is not large enough to express all images at once. For this reason, the information processing device 100 automatically scrolls the image content in a scrolling direction D02 inside the scrolling item SI02.

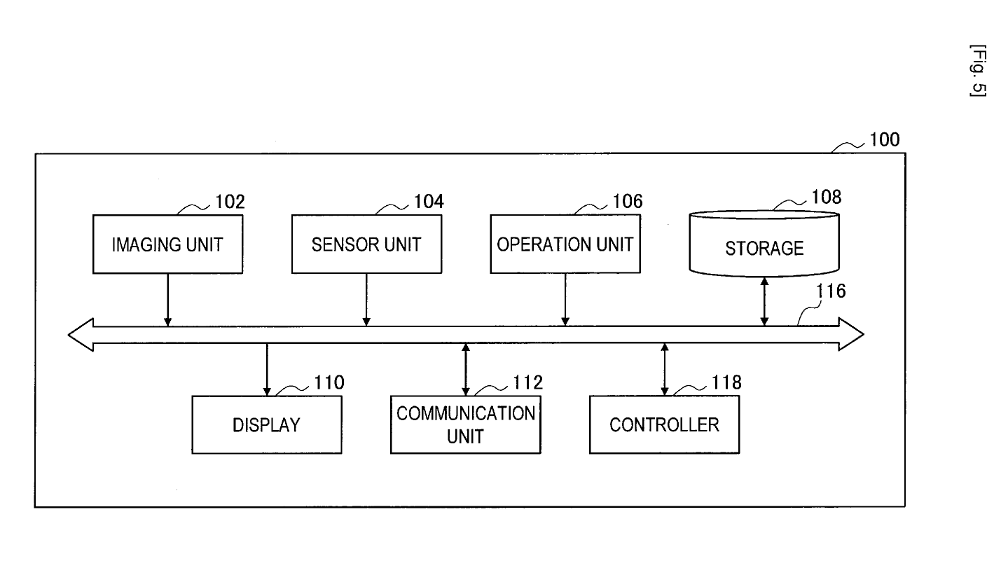

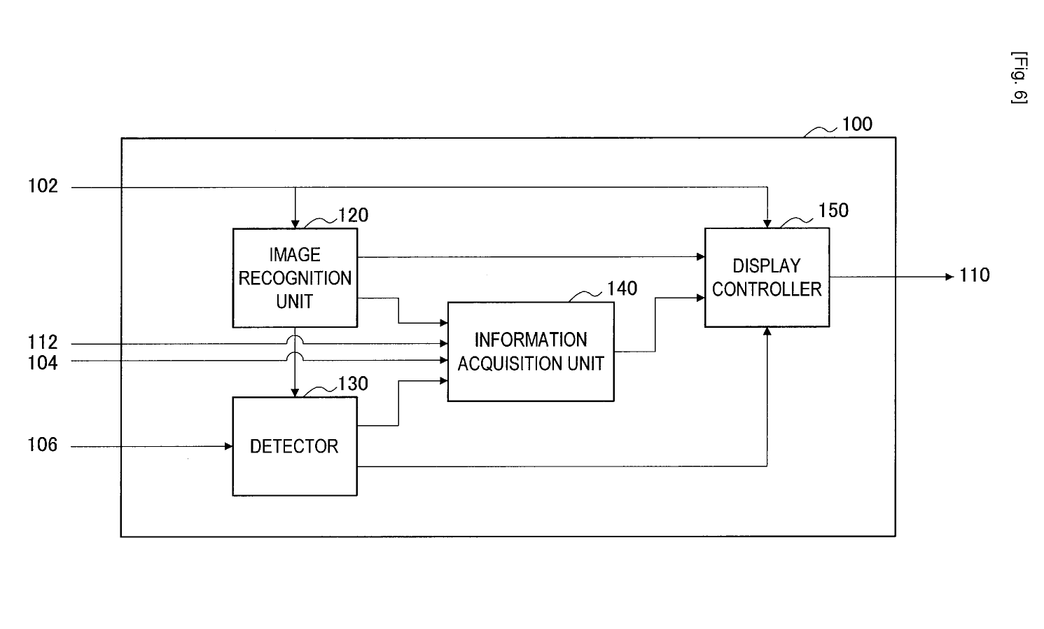

The scrolling items discussed above are information items virtually generated by the information processing device 100. In contrast, technology according to the present disclosure also handles information displayed by scrolling items in real space. FIG. 4 is an explanatory diagram for explaining a third example of a scrolling item. In the example in FIG. 4, a screen of the information processing device 100 is pointed towards an electronic sign in a real space RS1. The electronic sign is a display device which may be installed in a location such as a train station, for example, and automatically scrolls train schedule information in a scrolling direction D03. The information processing device 100 handles an information item displayed by the electronic sign appearing in a captured image as a scrolling item SI03. The information content of the scrolling item SI03 may be acquired via a communication unit of the information processing device 100.

These scrolling items provide much information to the user, without being operated by the user. However, automatic scrolling puts the times when the user wants to ascertain information out of synchronization with the times when information of interest to the user is displayed. For example, when the user looks at train schedule information, there is a possibility that the name of a delayed train line has already scrolled out of view. Also, even though the user may want to quickly ascertain the result of a sports game, there is a possibility of the user having to wait several seconds until that result is displayed. Thus, with the embodiment described in detail in the next section, there is provided a user interface that resolves such asynchronous timings and enables a user to efficiently acquire information.

### 2. CONFIGURATION OF DEVICE ACCORDING TO EMBODIMENT

### 2-1. Hardware Configuration

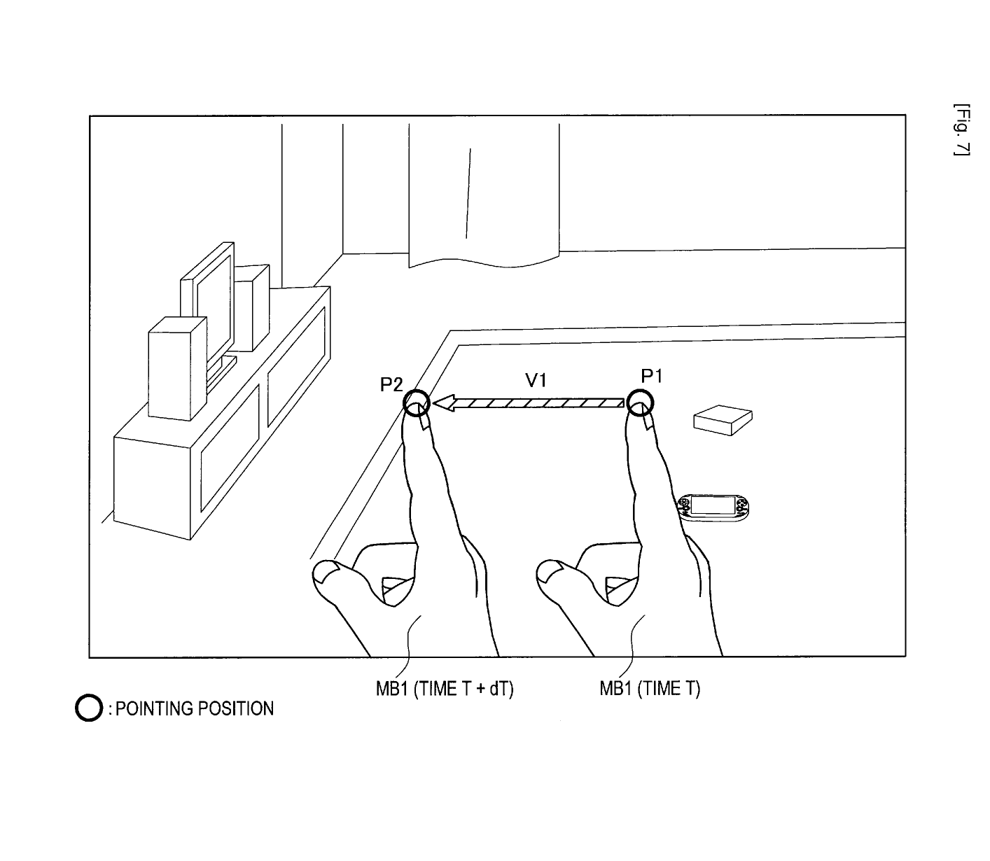

FIG. 5 is a block diagram illustrating an example of a hardware configuration of an information processing device 100 according to an embodiment. Referring to FIG. 5, the information processing device 100 is equipped with an imaging unit 102, a sensor unit 104, an operation unit 106, storage 108, a display 110, a communication unit 112, a bus 116, and a controller 118.

(1) Imaging Unit

The imaging unit 102 is a camera module that captures images. The imaging unit 102 includes a lens LN as illustrated by example in FIG. 1, a CCD, CMOS, or other image sensor, and an imaging circuit. The imaging unit 102 captures a real space in the user's visual field, and generates a captured image. A series of captured images generated by the imaging unit 102 may constitute video.

(2) Sensor Unit

The sensor unit 104 may include a positioning sensor that measures the position of the information processing device 100. The positioning sensor may be, for example, a Global Positioning System (GPS) sensor that receives GPS signals and measures the latitude, longitude, and altitude of the device. Otherwise, the positioning sensor may be a sensor that executes positioning on the basis of the strengths of wireless signals received from wireless access points. The sensor unit 104 outputs position data output from the positioning sensor to the controller 118.

(3) Operation Unit

The operation unit 106 is an operating interface used in order for a user to operate the information processing device 100 or input information into the information processing device 100. The operation unit 106 may receive user operations via the touch surface TS of a touch sensor as illustrated in FIG. 1, for example. Instead of (or in addition to) a touch sensor, the operation unit 106 may also includes other types of operating interfaces, such as buttons, switches, a keypad, or a speech input interface. Note that, as described later, user operations may also be detected via recognition of an operation object appearing in a captured image, rather than via these operating interfaces.

(4) Storage

The storage 108 is realized with a storage medium such as semiconductor memory or a hard disk, and stores programs and data used in processing by the information processing device 100. Note that some of the programs and data described in this specification may also be acquired from an external data source (such as a data server, network storage, or externally attached memory, for example), rather than being stored in the storage 108.

(5) Display

The display 110 is a display module that includes a screen arranged to enter a user's visual field (such as the pair of screens SCa and SCb illustrated in FIG. 1, for example), and a display circuit. The display 110 displays on-screen output images generated by a display controller 150 described later.

(6) Communication Unit

The communication unit 112 is a communication interface that mediates communication between the information processing device 100 and another device. The communication unit 112 supports an arbitrary wireless communication protocol or wired communication protocol, and establishes a communication connection with another device.

(7) Bus

The bus 116 connects the imaging unit 102, the sensor unit 104, the operation unit 106, the storage 108, the display 110, the communication unit 112, and the controller 118 to each other.

(8) Controller

The controller 118 corresponds to a processor such as a central processing unit (CPU) or a digital signal processor (DSP). The controller 118 causes various functions of the information processing device 100 described later to operate by executing a program stored in the storage 108 or another storage medium.

### 2-2. Functional Configuration

FIG. 6 is a block diagram illustrating an exemplary configuration of logical functions realized by the storage 108 and the controller 118 of the information processing device 100 illustrated in FIG. 5. Referring to FIG. 6, the information processing device 100 is equipped with an image recognition unit 120, a detector 130, an information acquisition unit 140, and a display controller 150.

(1) Image Recognition Unit

The image recognition unit 120 recognizes an operation object appearing in a captured image. An operation object may be an object such as a user's finger, leg, or a rod-like object held by a user, for example. Techniques for recognizing such operation objects appearing in a captured image are described in Japanese Unexamined Patent Application Publication No. 2011-203823 and Japanese Unexamined Patent Application Publication No. 2011-227649, for example. Upon recognizing an operation object appearing in a captured image, the image recognition unit 120 outputs to the detector 130 a recognition result indicating information such as the position of the recognized operation object within the image (the position of the tip of the operation object, for example) and the object's shape.

The image recognition unit 120 may also recognize an object or person appearing in a captured image. For example, the image recognition unit 120 may potentially recognize an object appearing in a captured image by using an established object recognition technology such as pattern matching. Also, the image recognition unit 120 may potentially recognize a person appearing in a captured image by using an established facial image recognition technology. The results of such image recognition executed by the image recognition unit 120 may be used to select which information to provide to a user, or to arrange information items on-screen. The image recognition unit 120 may also not execute object recognition and person recognition in the case of providing information independently of a captured image.

(2) Detector

The detector 130 detects user operations. For example, as a first technique, the detector 130 may detect motion of an operation object recognized from a captured image by the image recognition unit 120 as a user operation. In the case where the operation target item is a scrolling item, motion of an operation object in the scrolling direction of the scrolling item or the opposite direction thereto may be detected as a user operation for moving the scroll position of a scrolling item. The operation target item may be an item at a position overlapping an operation object in a captured image. A gesture by which a user specifies an operation target item may also be defined. For example, a gesture for specifying an operation target item may be a finger shape or motion performed so as to grab an item, or finger motion performed so as to press an item. Japanese Unexamined Patent Application Publication No. 2011-209965 describes a technique that determines a gesture performed so as to press an item on the basis of the change in the size of a finger in an image.

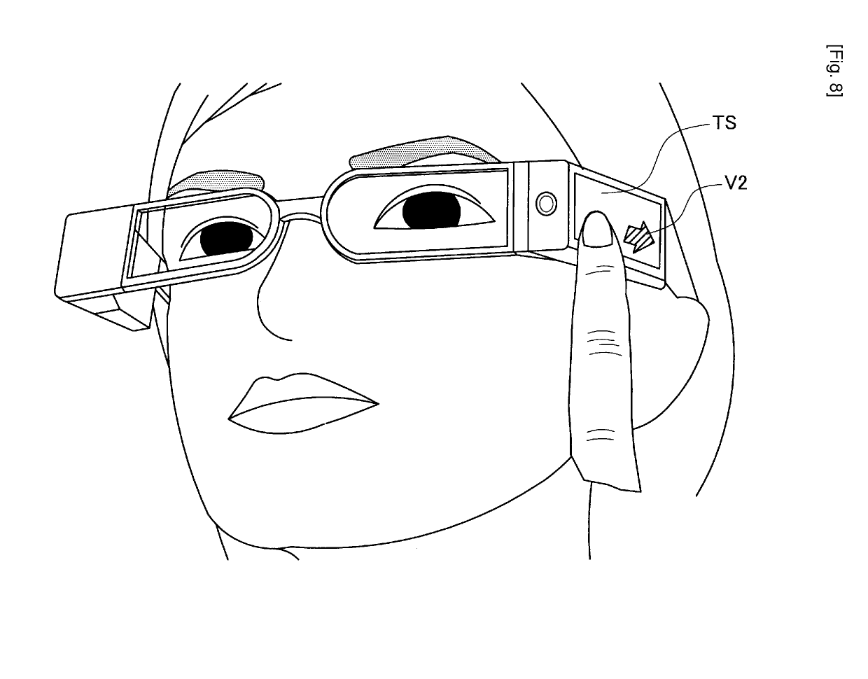

FIG. 7 is an explanatory diagram for explaining a first technique for detecting a user operation. FIG. 7 illustrates how an operation object MB1 is recognized in a captured image from a time T to a time T+dT. At time T, the operation object MB1 is pointing to a pointing position P1. Subsequently, the operation object MB1 moves to the left, and at time T+dT, the operation object MB1 is pointing to a pointing position P2. If a vector V1 from the position P1 to the position P2 is oriented in the scrolling direction of a scrolling item, the scrolling item may be fast-forwarded by a scrolling magnitude that depends on the size of the vector V1. If the orientation of the vector V1 is oriented in the opposite direction to the scrolling direction of a scrolling item, the scrolling item may be rewound by a scrolling magnitude that depends on the size of the vector V1.

Also, as a second technique, the detector 130 may detect a user's touch on the touch surface TS installed on the housing HS that supports a screen as illustrated in FIG. 1 as a user operation via the operation unit 106. A two-dimensional coordinate system of a capture image is associated with a two-dimensional coordinate system of the touch surface TS according to a coordinate conversion ratio, which may be tuned in advance. In the case where the operation target item is a scrolling item, a gesture in the scrolling direction of the scrolling item or the opposite direction thereto (such as a drag or flick, for example) may be detected as a user operation for moving the scroll position of a scrolling item. The operation target item may be an item at a position overlapping a pointing position (a position in a captured image corresponding to a touch position), for example. A touch gesture by which a user specifies an operation target item (such as a tap or double-tap, for example), may also be defined.

FIG. 8 is an explanatory diagram for explaining a second technique for detecting a user operation. FIG. 8 illustrates how a user touches the touch surface TS with his or her finger. When the finger moves, a vector V2 expressing the motion direction and motion magnitude is recognized. If the orientation of the vector V2 corresponds to the scrolling direction of a scrolling item, the scrolling item may be fast-forwarded by a scrolling magnitude that depends on the size of the vector V2. If the orientation of the vector V1 corresponds to the opposite direction to the scrolling direction of a scrolling item, the scrolling item may be rewound by a scrolling magnitude that depends on the size of the vector V2.

Note that techniques for detecting user operations are not limited to the examples described herein. For example, the detector 130 may also detect a user operation for moving the scroll position of a scrolling item via a physical operating mechanism such as directional keys, a wheel, a dial, or a switch installed on the housing HS. Other techniques for detecting user operations will be additionally described later.

Upon detecting a user operation, the detector 130 outputs a user operation event to the information acquisition unit 140 and the display controller 150. A user operation event may include data indicating the operation details, such as the pointing position, the operation vector (such as the vector V1 or V2 discussed above, for example), and the operation type (such as the gesture type, for example).

(3) Information Acquisition Unit

The information acquisition unit 140 acquires information to provide to a user. For example, the information acquisition unit 140 accesses a data server via the communication unit 112 and acquires information from the data server. Otherwise, the information acquisition unit 140 may also acquire information stored in the storage 108. The information acquisition unit 140 may also acquire information unique to a locality by using positioning data input from the sensor unit 104. The information acquisition unit 140 may also acquire additional information associated with an object or person appearing in a captured image recognized by the image recognition unit 120. The additional information may include information such as the name and attributes of the object or person, a related message, or a related advertisement.

The information acquisition unit 140 may also periodically acquire information at a fixed periodic interval. Otherwise, the information acquisition unit 140 may also acquire information in response to a trigger, such as the detection of a specific user operation or the activation of an information-providing application. For example, in the situation illustrated in FIG. 4, the electronic sign appearing in a captured image is recognized by the image recognition unit 120. Subsequently, if a user operation pointing to the scrolling item SI03 of the recognized electronic sign is detected, the information acquisition unit 140 causes the communication unit 112 to receive, from a data server, the information item displayed by the scrolling item SI03.

The information acquisition unit 140 outputs information which may be acquired by the various techniques discussed above to the display controller 150.

(4) Display Controller

The display controller 150 causes various information items to be displayed on-screen on the display 110 in order to provide a user with information input from the information acquisition unit 140. Information items displayed by the display controller 150 may include scrolling items and non-scrolling items. A scrolling item is an item whose information content automatically scrolls in a specific scrolling direction. The display controller 150 controls the display of scrolling items and non-scrolling items according to user operations detected by the detector 130.

In response to a specific user operation, the display controller 150 moves the scroll position of a scrolling item in a scrolling direction or the opposite direction to the scrolling direction. For example, in the case where a first user operation is detected, the display controller 150 rewinds a scrolling item by moving the scroll position of the scrolling item in the opposite direction to the scrolling direction. Thus, it becomes possible for a user to once again view information that has already scrolled out of view. Also, in the case where a second user operation is detected, the display controller 150 fast-forwards a scrolling item by moving the scroll position of the scrolling item in the scrolling direction. Thus, it becomes possible for a user to rapidly view information that is not yet being displayed by the scrolling item. Furthermore, in the case where multiple information items are displayed on-screen, the display controller 150 may also select an item to control from the multiple information items according to a third user operation. As an example, the first user operation and the second user operation may be motions of an operation object as described using FIG. 7, or a touch gesture as described using FIG. 8. The third user operation may be a specific shape or motion of an operation object, or a specific touch gesture.

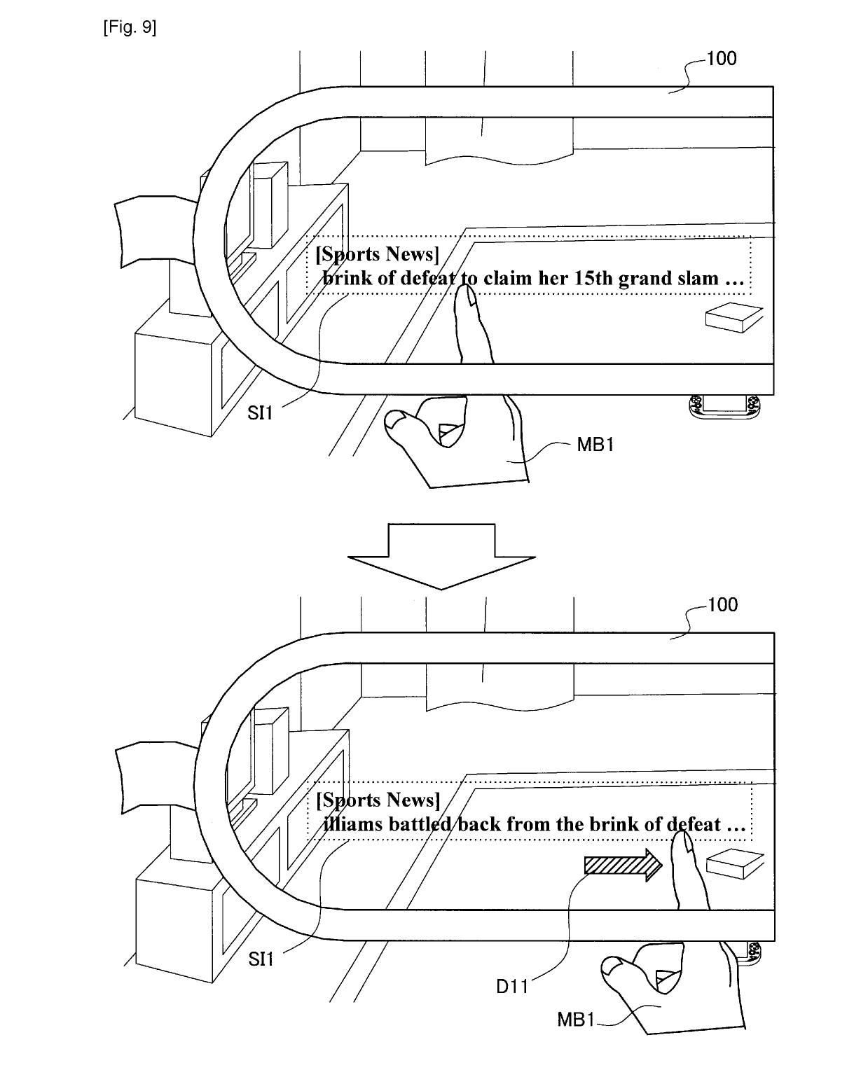

FIG. 9 is an explanatory diagram for explaining an example of rewinding the scroll position according to a user operation. Referring to the upper part of FIG. 9, a scrolling item SI1 is being displayed on-screen in the information processing device 100. The display controller 150 automatically scrolls to the left a string stating news content inside the scrolling item SI1. An operation object MB1 is pointing to the scrolling item SI1 Subsequently, if the user moves the operation object MB1 in a direction D11, the display controller 150 rewinds the scrolling item SI1, as illustrated in the lower part of FIG. 9. The scroll position of the scrolling item SI1 moves to the right along the direction D11. For example, FIG. 9 demonstrates how the word “brink” moves to the right. The user is then able to view the first half of the news content he or she missed.

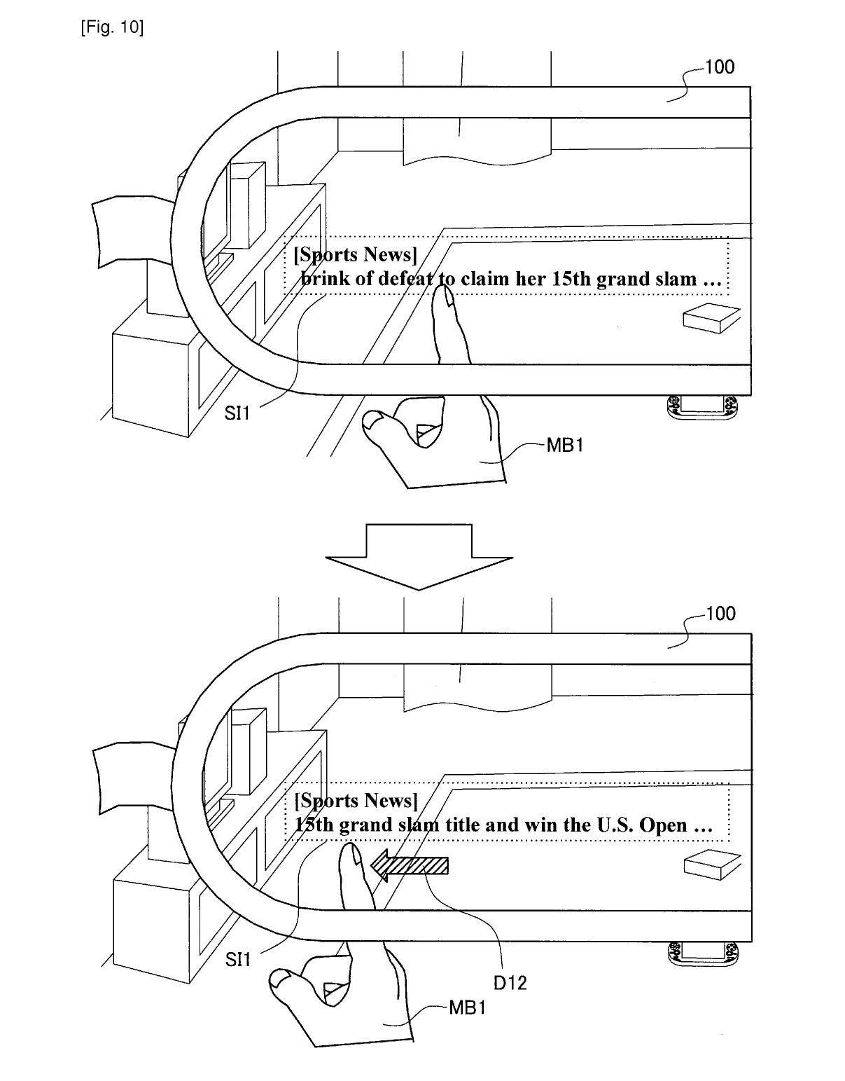

FIG. 10 is an explanatory diagram for explaining an example of fast-forwarding the scroll position according to a user operation. Referring to the upper part of FIG. 10, a scrolling item SI1 is being displayed on-screen in the information processing device 100. The display controller 150 automatically scrolls to the left a string stating news content inside the scrolling item SI1. An operation object MB1 is pointing to the scrolling item SI1 Subsequently, if the user moves the operation object MB1 in a direction D12, the display controller 150 fast-forwards the scrolling item SI1, as illustrated in the lower part of FIG. 10. The scroll position of the scrolling item SI1 moves to the left along the direction D12. For example, FIG. 10 demonstrates how the phrase “grand slam” moves to the left. The user is then able to rapidly view the second half of the news content he or she wants to see quickly.

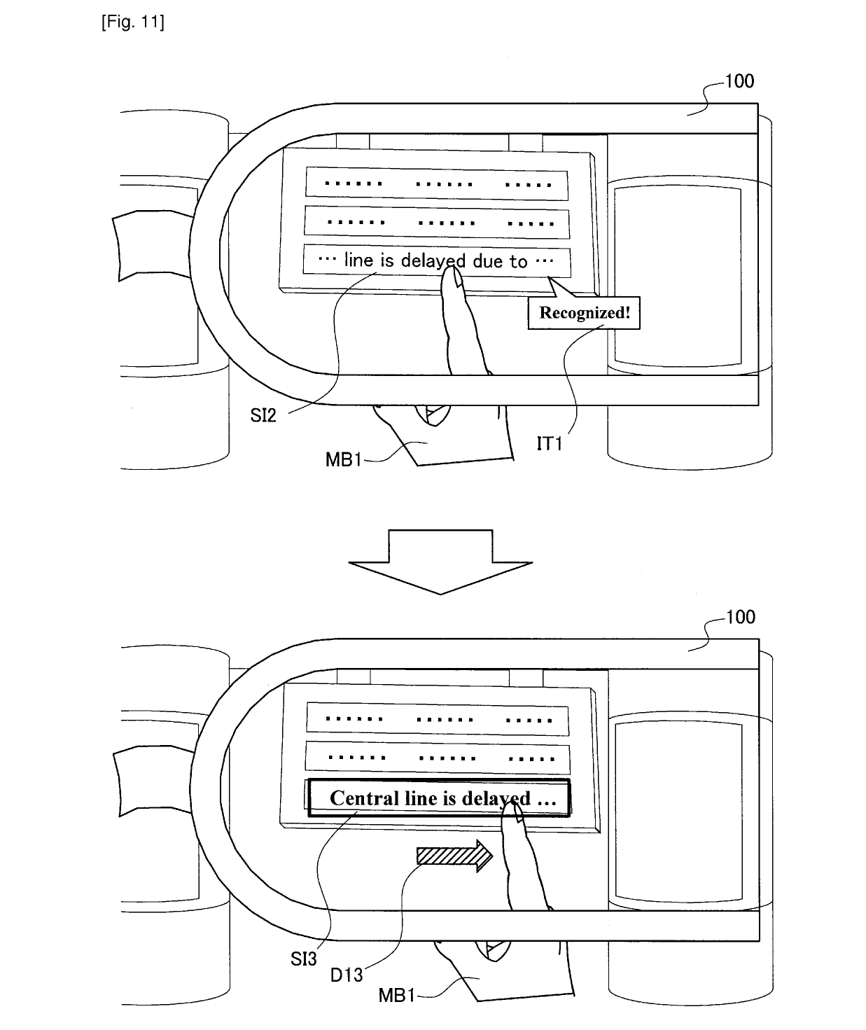

FIG. 11 is an explanatory diagram for explaining another example of rewinding the scroll position according to a user operation. Referring to the upper part of FIG. 11, a scrolling item SI2 being displayed by a display device in a real space appears on-screen in the information processing device 100. When the image recognition unit 120 successfully recognizes the scrolling item SI2, the display controller 150 superimposes an indication IT1 reporting the successful recognition over the scrolling item SI2 on-screen. An operation object MB1 is pointing to the scrolling item SI2. Subsequently, the user moves the operation object MB1 in a direction D13, as illustrated in the lower part of FIG. 11. When such a user operation is detected by the detector 130, the information acquisition unit 140 acquires the information item displayed by the scrolling item SI2 from a data server via the communication unit 112. The display controller 150 then generates a scrolling item SI3 that displays the acquired information, and after arranging the generated scrolling item SI3 on-screen, rewinds the scrolling item SI3. The scroll position of the scrolling item SI3 moves to the right along the direction D13. For example, FIG. 11 demonstrates how the word “delayed” moves to the right. As a result, the user is able to view the first half of information being scrolled in a real space (in the example in FIG. 11, train schedule information). Thus, the first half of the information is scrolled in reverse chronological order on the display based on the user command.

### 3. PROCESS FLOWS

### 3-1. Overall Flow

### (1) First Example

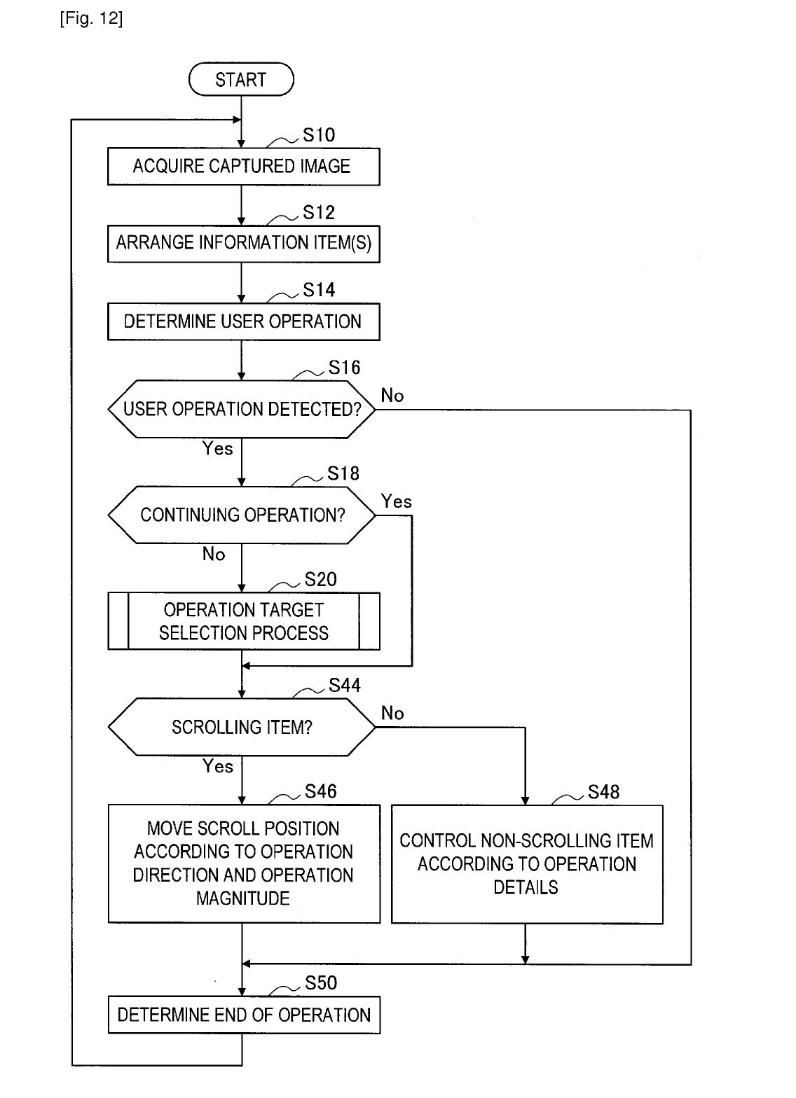

FIG. 12 is a flowchart illustrating a first example of the flow of a display control process executed by the information processing device 100. In the first example, information is provided to a user via an information item virtually generated by the display controller 150.

Referring to FIG. 12, first, the display controller 150 acquires a captured image generated by the imaging unit 102 (step S10). Next, the display controller 150 arranges on-screen one or more information items that express information acquired by the information acquisition unit 140 (step S12). The one or more information items arranged at this point may include at least one of scrolling items and non-scrolling items. The display controller 150 may also arrange information items at positions associated with objects or persons recognized by the image recognition unit 120, or arrange information items at positions that do not depend on image recognition.

The detector 130 monitors the results of operation object recognition executed by the image recognition unit 120 or input from the operation unit 106, and determines a user operation (step S14). Then, when the detector 130 detects a user operation (step S16), the process proceeds to step S18. Meanwhile, if a user operation is not detected, the process proceeds to step S50.

In the case where the detector 130 detects a user operation, the display controller 150 determines whether or not the operation is continuing from a previous frame (step S18). In the case where the operation is not continuing from a previous frame, the display controller 150 selects an operation target item by executing an operation target selection process described later (step S20). In the case where the operation is continuing, the operation target item from the previous frame is maintained.

Next, the display controller 150 determines whether or not the operation target item is a scrolling item (step S44). In the case where the operation target item is a scrolling item, the display controller 150 moves the scroll position of the operation target item in accordance with the direction (operation direction) and size (operation magnitude) of the operation vector (step S46). In the case where the operation target item is a non-scrolling item, the display controller 150 controls the non-scrolling item in accordance with the operation details indicated by the user operation event (step S48).

Next, the display controller 150 determines the end of the operation (step S50). For example, in the case where a user operation is not detected in step S16, the display controller 150 may determine that an operation continuing from a previous frame has ended. The display controller 150 may also determine that a continuing operation has ended in the case where a specific amount of time has elapsed since the start of the operation. In addition, the display controller 150 may also determine that a continuing operation has ended in the case where the operation direction changes suddenly (such as in the case where the drag direction changes direction at an angle exceeding a specific threshold value, for example). Defining such determination conditions for the end of an operation enables the prevention of scrolling that was unintended by the user as a result of the scroll position over-tracking an operation object appearing in a captured image.

The display controller 150, upon determining that a continuing operation has ended, releases the operation target item. In the case where the operation target item is a scrolling item, the display controller 150 may also stop automatic scrolling of the operation target item while an operation continues. After that, the process returns to step S10, and the above process is repeated for the next frame.

### (2) Second Example

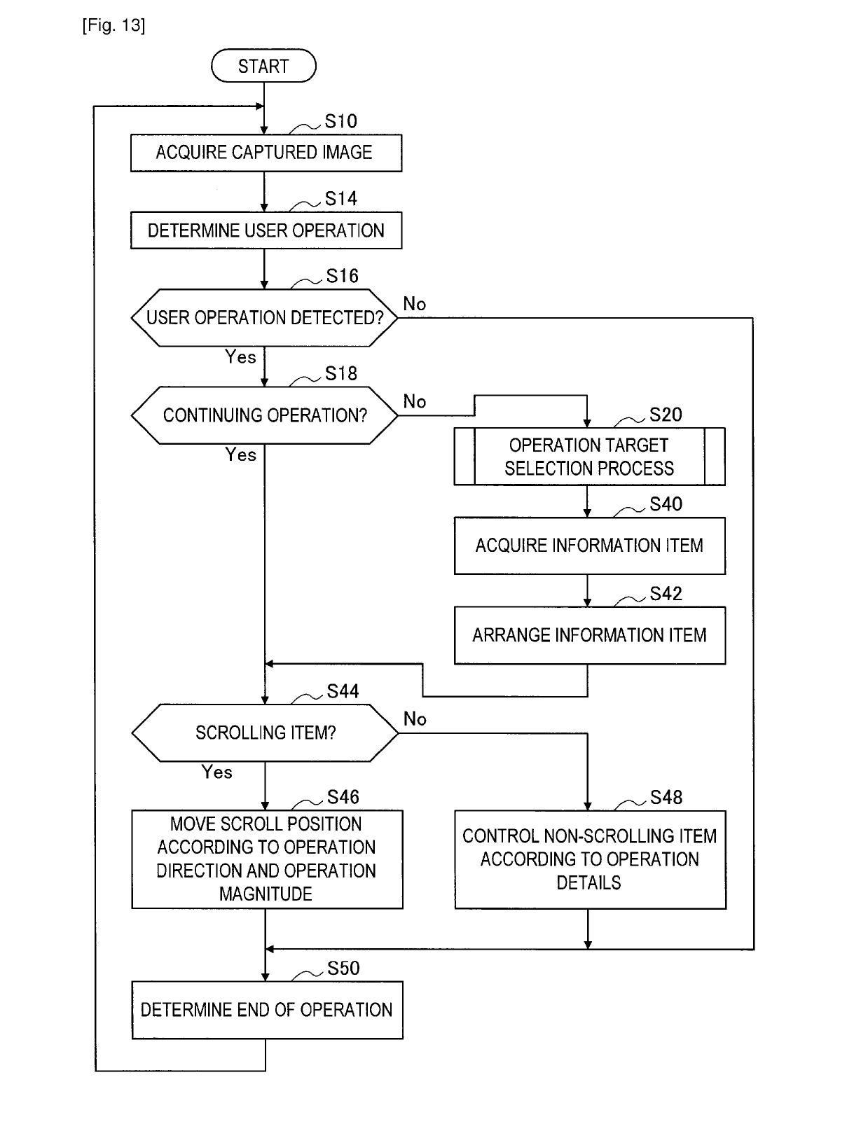

FIG. 13 is a flowchart illustrating a second example of the flow of a display control process executed by the information processing device 100. In the second example, the information processing device 100 recognizes an information item displayed by a display device in a real space.

Referring to FIG. 13, first, the display controller 150 acquires a captured image generated by the imaging unit 102 (step S10).

The detector 130 monitors the results of image recognition executed by the image recognition unit 120 or input from the operation unit 106, and determines a user operation (step S14). Then, when the detector 130 detects a user operation (step S16), the process proceeds to step S18. Meanwhile, if a user operation is not detected, the process proceeds to step S50.

In the case where the detector 130 detects a user operation, the display controller 150 determines whether or not the operation is continuing from a previous frame (step S18). In the case where the operation is not continuing from a previous frame, the display controller 150 selects an operation target item by executing an operation target selection process described later (step S20). The operation target item selected at this point is an information item in a real space recognized by the image recognition unit 120. Next, the information acquisition unit 140 acquires the information item selected as the operation target item via the communication unit 112 (step S40). Next, the display controller 150 arranges on-screen the information item acquired by the information acquisition unit 140 (step S42). In the case where the operation is continuing, the operation target item from the previous frame is maintained.

Next, the display controller 150 determines whether or not the operation target item is a scrolling item (step S44). In the case where the operation target item is a scrolling item, the display controller 150 moves the scroll position of the operation target item in accordance with the operation direction and operation magnitude indicated by the user operation event (step S46). In the case where the operation target item is a non-scrolling item, the display controller 150 controls the non-scrolling item in accordance with the operation details indicated by the user operation event (step S48).

Next, the display controller 150 determines the end of the operation according to conditions like those described in association with FIG. 12 (step S50). The display controller 150, upon determining that a continuing operation has ended, releases the operation target item. For example, the display controller 150 may make an operation target item being displayed superimposed onto an object in a real space disappear from the screen. After that, the process returns to step S10, and the above process is repeated for the next frame.

### 3-2. Operation Target Selection Process

### (1) First Example

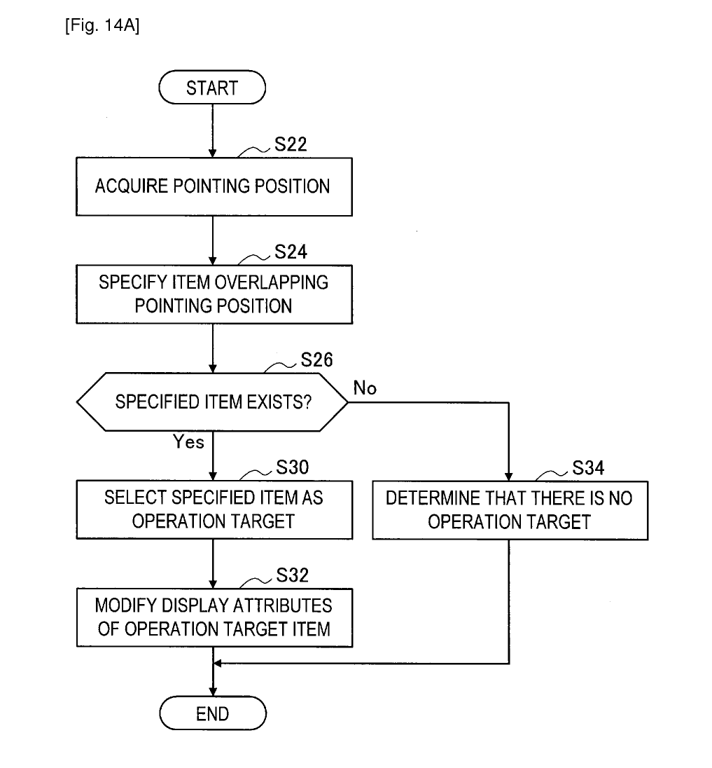

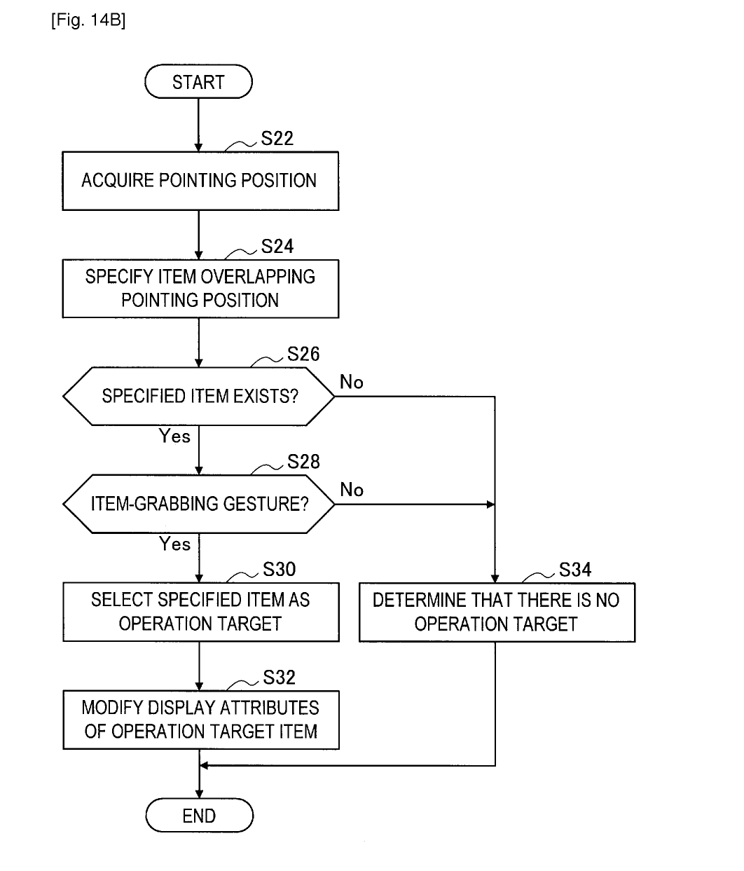

FIG. 14A is a flowchart illustrating a first example of a detailed flow of the operation target selection process illustrated in FIGS. 12 and 13.

Referring to FIG. 14A, first, the display controller 150 acquires a pointing position indicated by a user operation event (step S22). Next, the display controller 150 specifies an item overlapping the acquired pointing position (step S24). The item specified at this point may be an information item that is virtually generated and arranged on-screen, or an information item that is recognized within a captured image by the image recognition unit 120. In the case where an item overlapping the pointing position does not exist, the display controller 150 may specify an item at the position closest to the pointing position. Also, in the case where multiple items overlapping the pointing position exist, any one of the items may be specified according to particular conditions, such as prioritizing the item positioned farthest in front.

Next, the display controller 150 determines whether or not a specified item exists on the basis of the pointing position (step S26). In the case where a specified item exists, the display controller 150 selects the specified item as the operation target item (step S30). The display controller 150 then modifies the display attributes of the selected operation target item to enable the user to ascertain which operation target item has been selected (step S32). For example, display attributes such as the size, color, shape, brightness, transparency, depth, or outline width of the operation target item may be modified. In the case where an information item in a real space is selected as the operation target item, an indication reporting the selection may also be superimposed onto the operation target item. In the case where a specified item does not exist in step S24, the display controller 150 determines that there is no operation target item (step S34).

### (2) Second Example

FIG. 14B is a flowchart illustrating a second example of a detailed flow of the operation target selection process illustrated in FIGS. 12 and 13. The second example assumes that a user operation is performed using an operation object as illustrated by example in FIG. 7.

Referring to FIG. 14B, first, the display controller 150 acquires a pointing position indicated by a user operation event (step S22). Next, the display controller 150 specifies an item overlapping the acquired pointing position (step S24).

Next, the display controller 150 determines whether or not a specified item exists on the basis of the pointing position (step S26). In the case where a specified item exists, the display controller 150 additionally determines whether or not a gesture grabbing the item has been performed (step S28). In the case where a gesture grabbing the item has been performed, the display controller 150 selects the specified item as the operation target item (step S30). The display controller 150 then modifies the display attributes of the selected operation target item to enable the user to ascertain which operation target item has been selected (step S32). In the case where a specified item does not exist in step S24, or a gesture grabbing the item has not been performed, the display controller 150 determines that there is no operation target item (step S34).

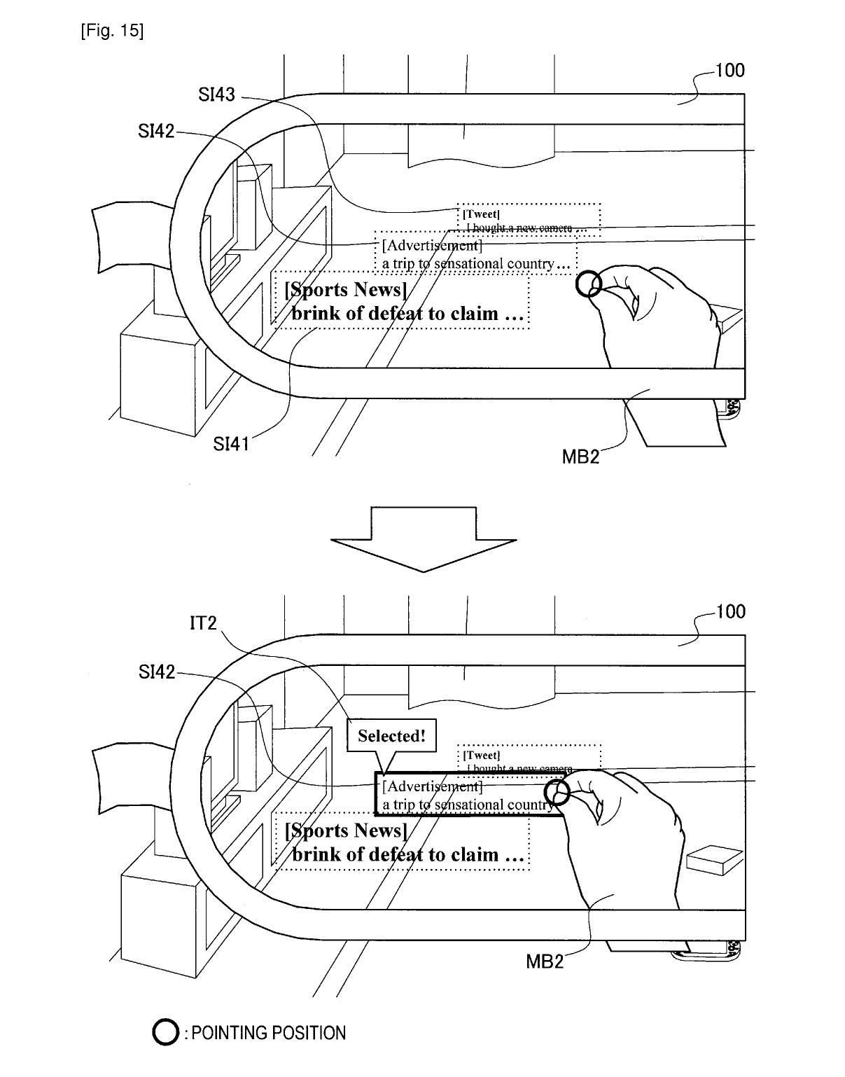

FIG. 15 is an explanatory diagram for explaining the selection of an operation target item based on a gesture determination as above. Referring to the upper part of FIG. 15, scrolling items SI41, SI42, and SI43 are being displayed on-screen in the information processing device 100. Note that the display 110 is herein assumed to support three-dimensional (3D) display. The scrolling item SI41 is arranged farthest in front with the shallowest depth, while the scrolling item SI43 is arranged farthest in back with the deepest depth, and the scrolling item SI42 is arranged in between. An operation object MB2 is performing a gesture (including shape) of grabbing an item, but the pointing position is not overlapping any of the items. Subsequently, when the user moves the operation object MB2, the pointing position of the operation object MB2 overlaps the scrolling item SI42, as illustrated in the lower part of FIG. 15. At this point, the display controller 150 selects the scrolling item SI42 as the operation target item, and modifies the outline width of the scrolling item SI42 while also superimposing an indication IT2 reporting the selection onto the scrolling item SI42.

By introducing such a gesture determination, it is possible to prevent an information item being mistakenly operated as a result of an operation object such as a user's fingers appearing in a captured image, even though the user does not intend to perform an operation. In addition, the user becomes able to specify an operation target item with an intuitive gesture of grabbing an item.

### 3-3. Additional Display Control

The display controller 150 may not only control the scroll position of a scrolling item, but also control various display attributes of an operation target item according to a user operation. Two examples of such display control will be described in this section.

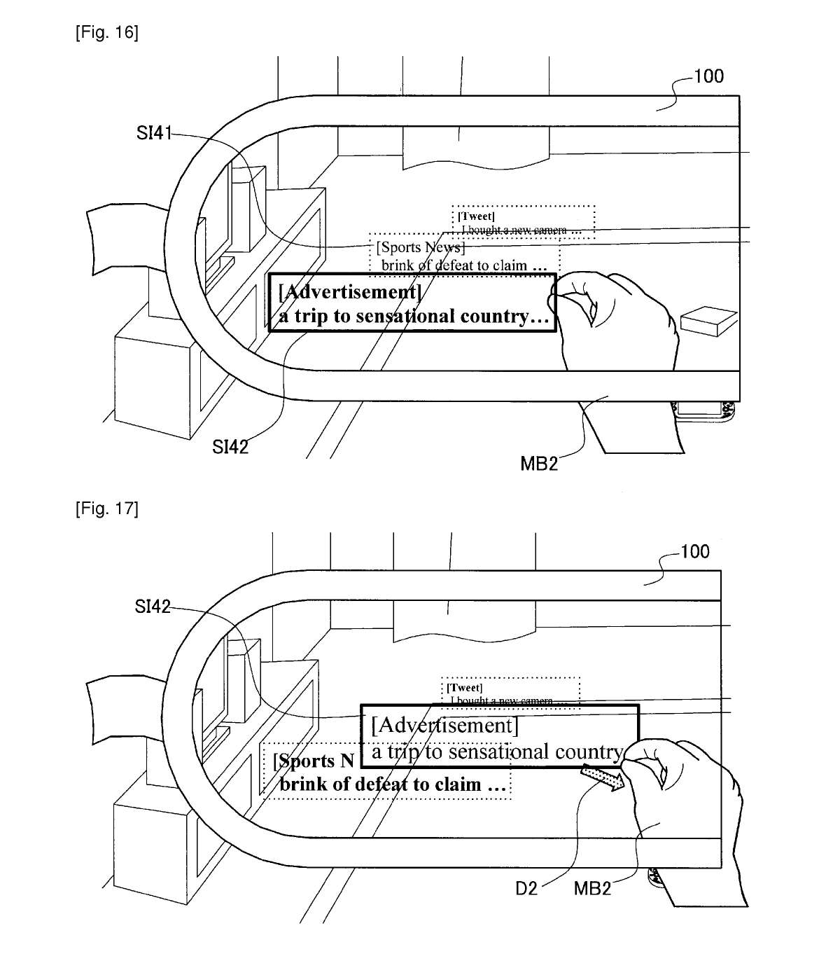

FIG. 16 is a first explanatory diagram for explaining additional display control according to a user operation. FIG. 16 illustrates an example of the on-screen state of the information processing device 100 after a short time has passed since the state illustrated in the upper part of FIG. 15. After the scrolling item SI42 is selected by the operation object MB2, the scrolling item SI42 is moved in front of the scrolling item SI41 as a result of the user moving the operation object MB2 towards him- or herself.

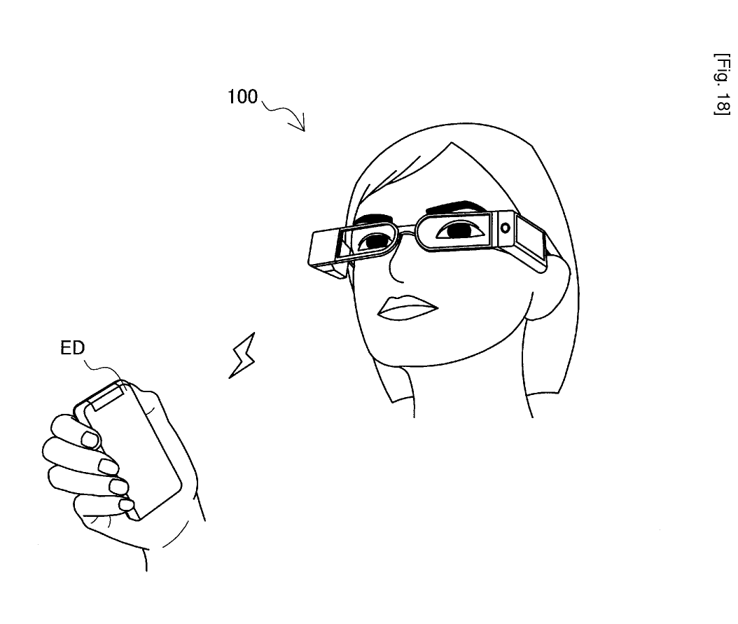

FIG. 17 is a second explanatory diagram for explaining additional display control according to a user operation. FIG. 17 illustrates another example of the on-screen state of the information processing device 100 after a short time has passed since the state illustrated in the upper part of FIG. 15. After the scrolling item SI42 is selected by the operation object MB2, the display size of the scrolling item SI42 is enlarged as a result of the user moving the operation object MB2 downward and to the right along a direction D2. Such a size modification may also be executed only in the case where the pointing position is in a corner portion of an information item.

With the depth or display size control as described in this section, a user is able to more clearly perceive the contents of a scrolling item that he or she wants to view. Moreover, operations such as fast-forwarding and rewinding a scrolling item also become easier.

Note that in the case where the screen of the display 110 includes a filter that transmits outside light according to a variable transmittance, the display controller 150 is able to allow a user to clearly perceive display items by varying the transmittance of the filter. However, if the battery level of the information processing device 100 reaches zero, the transmittance of the filter may become unchangeable. Consequently, the display controller 150 may set the filter transmittance to maximum, and maintain the maximum transmittance while the battery level of the information processing device 100 is below a specific threshold value. Thus, it is possible to preemptively avoid situations in which a user's actions are impeded because the transmittance is unchangeable with the screen in a dark state.

### 4. LINKING WITH EXTERNAL DEVICE

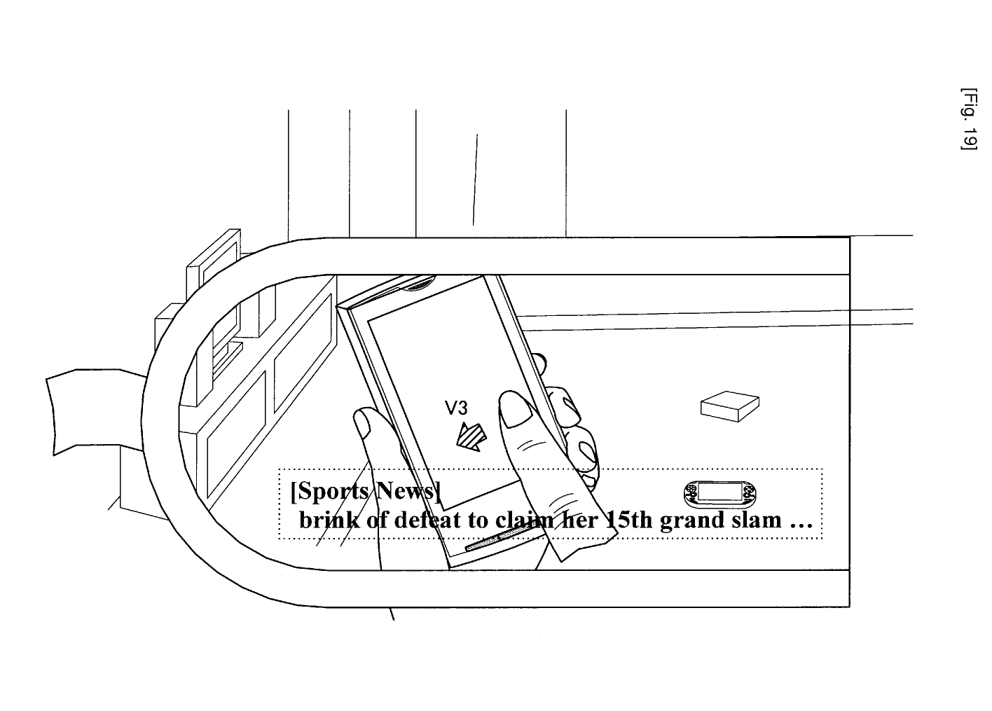

The functionality of the information processing device 100 discussed above may also be realized by the linkage of multiple devices. FIG. 18 illustrates the information processing device 100 illustrated by example in FIG. 1, and an external device ED. The external device ED is a mobile client such as a smartphone or a mobile PC. The information processing device 100 wirelessly communicates with the external device ED using an arbitrary wireless communication protocol such as wireless local area network (LAN), Bluetooth (registered trademark), or Zigbee. In addition, one or more of the various logical functions of the information processing device 100 illustrated in FIG. 6 may be executed in the external device ED. For example, object recognition and person recognition are processes that demand comparatively high processor performance. Consequently, by implementing such image recognition processes on the external device ED, it becomes possible to realize the information processing device 100 as a low-cost, lightweight, and compact device.

As another example, the external device ED may also be utilized as mechanism of operating the information processing device 100. FIG. 19 is an explanatory diagram for explaining a third technique for detecting a user operation. FIG. 19 illustrates how a user touches a touch surface installed in the external device ED with his or her finger. When the finger moves, a vector V3 expressing the movement direction and movement magnitude is recognized. The detector 130 detects such a user operation conducted on the external device ED via the communication unit 112. The detector 130 converts the vector V3 on the touch surface of the external device ED into a corresponding vector on-screen on the information processing device 100. Then, if the orientation of the converted vector corresponds to the scrolling direction of a scrolling item, the scrolling item may be fast-forwarded. If the orientation of the converted vector corresponds to the opposite direction to the scrolling direction, the scrolling item may be rewound. Note that the external device ED may also not appear on-screen on the information processing device 100. By utilizing an external device as an operating mechanism in this way, a user is able to operate a scrolling item without seeming suspicious to nearby persons, even in situations where operating a device worn on the head or raising an operation object forwards would be unnatural.

### 5. CONCLUSION

The foregoing thus describes an embodiment of technology according to the present disclosure in detail using FIGS. 1 to 19. According to the foregoing embodiment, the display of a scrolling item that automatically scrolls on the screen of a display worn by a user is controlled according to user operations. Consequently, it is possible to resolve the asynchronization between the times when the user wants to ascertain information and the times when information of interest to the user is displayed in the case of providing information via a scrolling item. As a result, the user becomes able to efficiently acquire information provided by a wearable device.

For example, according to the foregoing embodiment, the scroll position of a scrolling item is moved in a scrolling direction or the opposite direction according to a specific user operation. Consequently, a user is able to view missed information or information not yet displayed at his or her own desired timings.

In addition, according to the foregoing embodiment, motion in a scrolling direction or the opposite direction of an operation object appearing in a captured image may be detected as the specific user operation above. In this case, the user is able to view information of interest in a timely manner with the easy and intuitive action of moving his or her own finger (or some other operation object) before his or her eyes.

Also, according to the foregoing embodiment, the above specific user operation may be detected via an operation unit installed on a housing that supports the above screen. In this case, robust operations that are unaffected by the precision of image recognition become possible. Moreover, since the operation unit is integrated with a wearable device such as a head-mounted display, control response with respect to operations does not suffer as a result of communication lag, nor does the portability of the device decrease.

Note that the series of processes conducted by the information processing devices described in this specification may be realized in any of software, hardware, and a combination of software and hardware. Programs constituting software are stored in advance in a non-transitory medium provided internally or externally to each device, for example. Each program is then loaded into random access memory (RAM) at runtime and executed by a processor such as a CPU, for example.

The foregoing thus describes preferred embodiments of the present disclosure in detail and with reference to the attached drawings. However, the technical scope of the present disclosure is not limited to such examples. It is clear to persons ordinarily skilled in the technical field of the present disclosure that various modifications or alterations may occur insofar as they are within the scope of the technical ideas stated in the claims, and it is to be understood that such modifications or alterations obviously belong to the technical scope of the present disclosure.

Additionally, the present technology may also be configured as below.

(1) An apparatus including:

a display control circuit configured to control a display to display content; and

a user input circuit configured to receive a command from the user,

wherein the display control circuit is configured to modify scrolling of content being automatically scrolled in a first direction based on the command from the user.

(2) The apparatus according to (1), wherein the display control circuit is configured to automatically scroll the content in the first direction before the command is received from the user.

(3) The apparatus according to (1) or (2), wherein an external device is configured to automatically scroll the content in the first direction before the command is received from the user.

(4) The apparatus according to (1) to (3), wherein the display control circuit is configured to scroll the content in a direction opposite first direction or in the first direction at a fast forward speed based on the command from the user.

(5) The apparatus according to (1) to (4), further comprising:

an eyeglass frame onto which is mounted the display control circuit and the user input circuit; and

a display mounted in the eyeglass frame and configured to display images generated by the display control circuit.

(6) The apparatus according to (5), further comprising:

an imaging device mounted on the eyeglass frame and configured to generate images.

(7) The apparatus according to (6), wherein the user input circuit includes a gesture recognition circuit configured to recognize a gesture of the user from the images generated by the imaging device, and the display control circuit is configured to modify scrolling of the content based on the gesture of the user.

(8) The apparatus according to (5), further comprising:

an input unit mounted on the eyeglass frame and configured to detect a gesture from the user when the user operates the input unit.

(9) The apparatus according to (8), wherein the user input circuit includes a gesture recognition circuit configured to recognize the gesture of the user detected by the input unit, and the display control circuit is configured to modify scrolling of the content based on the gesture of the user.

(10) The apparatus according to (6), further comprising:

an image recognition circuit which recognizes scrolling objects in the images generated by the imaging unit.

(11) The apparatus according to (10), wherein the display control circuit is configured to scroll the scrolling objects recognized by the image recognition circuit in reverse chronological order based on the command from the user.

(12) The apparatus according to (1) to (11), wherein the display control circuit is configured to move the content in two different directions based on the command from the user.

(13) The apparatus according to (1) to (12), wherein the display control circuit is configured to modify an outline of the content when modifying scrolling of the content.

(14) The apparatus according to (1) to (13), wherein the display control circuit is configured to move the content to a shallower depth on the display based on the command from the user.

(15) The apparatus according to (14), wherein the display control circuit is configured to move the content to the shallower depth on the display such that the content overlaps second content on the display.

(16) The apparatus according to (1) to (15), further comprising:

a communication unit configured to communicate with an external device,
wherein the user input circuit receives the user command from the external device through the communication unit.

(17) The apparatus according to (16), wherein the user input circuit includes a gesture recognition circuit configured to recognize the gesture of the user detected by an input unit, and the display control circuit is configured to modify scrolling of the content based on the gesture of the user.

(18) The apparatus according to (6), further comprising:

a content selection unit configured to select the content being scrolled based on the gesture of the user.

(19) A method including:

receiving a command from the user; and
modifying, using a processor, scrolling of content being automatically scrolled in a first direction based on the command from the user.

(20) A non-transitory computer readable medium encoded with computer readable instructions that, when performed by a processor, cause the processor to perform the method according to (19).

Additionally, the present technology may also be configured as below.

(1)

An information processing device including:

a display, worn by a user, that includes a screen arranged to enter a visual field of the user;

a detector that detects a user operation; and

a display controller that controls display of a scrolling item that automatically scrolls in a first direction on the screen according to the user operation detected by the detector.

(2)

The information processing device according to (1), wherein

the display controller moves a scroll position of the scrolling item in the first direction or a direction opposite to the first direction according to a specific user operation.

(3)

The information processing device according to (2), wherein

the display controller rewinds the scroll position in the opposite direction according to a first user operation.

(4)

The information processing device according to (2) or (3), wherein

the display controller fast-forwards the scroll position in the first direction according to a second user operation.

(5)

The information processing device according to any one of (2) to (4), further including:

an imaging unit that captures a real space in the visual field of the user, and generates a captured image,

wherein the detector detects motion in the first direction or the opposite direction of an operation object appearing in the captured image as the specific user operation.

(6)

The information processing device according to any one of (2) to (4), wherein

the detector detects the specific user operation via an operation unit installed on a housing that supports the screen.

(7)

The information processing device according to any one of (2) to (4), further including:
a communication unit that communicates with a mobile client carried by the user,
wherein the detector detects the specific user operation conducted on the mobile client via the communication unit.

(8)

The information processing device according to any one of (1) to (7), wherein the display controller causes the screen to display a plurality of information items including the scrolling item, and selects an item to be controlled from among the plurality of information items according to a third user operation.

(9)

The information processing apparatus according to any one of (1) to (8), wherein the display controller changes a depth of the scrolling item according to a fourth user operation.

(10)

The information processing device according to any one of (1) to (9), wherein the display controller changes a display size of the scrolling item according to a fifth user operation.

(11)

The information processing device according to any one of (1) to (10), wherein the scrolling item is a virtually generated information item.

(12)

The information processing device according to any one of (1) to (10),
wherein the scrolling item is an information item displayed by a display device in a real space,
wherein the information processing device further includes
an imaging unit that captures the real space, and generates a captured image, and
a communication unit that receives the information item on the display device recognized in the captured image,
wherein the display controller causes the screen to display the information item received by the communication unit, and controls display of the information item according to the user operation.

(13)

A display control method executed by a controller of an information processing device equipped with a display, worn by a user, that includes a screen arranged to enter a visual field of the user, the display control method including:
detecting a user operation; and
controlling display of a scrolling item that automatically scrolls in a first direction on the screen according to the detected user operation.

(14)

A program for causing a computer that controls an information processing device equipped with a display, worn by a user, that includes a screen arranged to enter a visual field of the user to function as:
a detector that detects a user operation; and
a display controller that controls display of a scrolling item that automatically scrolls in a first direction on the screen according to the user operation detected by the detector.

### REFERENCE SIGNS LIST

100 information processing device
102 imaging unit
106 operation unit
110 display
112 communication unit
120 image recognition unit
130 detector
140 information acquisition unit
150 display controller

1. An apparatus comprising:
a display control circuit configured to control a display to display content; and
a user input circuit configured to receive a command from the user,
wherein the display control circuit is configured to modify scrolling of content being automatically scrolled in a first direction based on the command from the user.

2. The apparatus according to claim 1, wherein the display control circuit is configured to automatically scroll the content in the first direction before the command is received from the user.

3. The apparatus according to claim 1, wherein an external device is configured to automatically scroll the content in the first direction before the command is received from the user.

4. The apparatus according to claim 1, wherein the display control circuit is configured to scroll the content in a direction opposite first direction or in the first direction at a fast forward speed based on the command from the user.

5. The apparatus according to claim 1, further comprising:
an eyeglass frame onto which is mounted the display control circuit and the user input circuit; and
a display mounted in the eyeglass frame and configured to display images generated by the display control circuit.

6. The apparatus according to claim 5, further comprising:
an imaging device mounted on the eyeglass frame and configured to generate images.

7. The apparatus according to claim 6, wherein the user input circuit includes a gesture recognition circuit configured to recognize a gesture of the user from the images generated by the imaging device, and the display control circuit is configured to modify scrolling of the content based on the gesture of the user.

8. The apparatus according to claim 5, further comprising:
an input unit mounted on the eyeglass frame and configured to detect a gesture from the user when the user operates the input unit.

9. The apparatus according to claim 8, wherein the user input circuit includes a gesture recognition circuit configured to recognize the gesture of the user detected by the input unit, and the display control circuit is configured to modify scrolling of the content based on the gesture of the user.

10. The apparatus according to claim 6, further comprising:
an image recognition circuit which recognizes scrolling objects in the images generated by the imaging unit.

11. The apparatus according to claim 10, wherein the display control circuit is configured to scroll the scrolling objects recognized by the image recognition circuit in reverse chronological order based on the command from the user.

12. The apparatus according to claim 1, wherein the display control circuit is configured to move the content in two different directions based on the command from the user.

13. The apparatus according to claim 1, wherein the display control circuit is configured to modify an outline of the content when modifying scrolling of the content.

14. The apparatus according to claim 1, wherein the display control circuit is configured to move the content to a shallower depth on the display based on the command from the user.

15. The apparatus according to claim 14, wherein the display control circuit is configured to move the content to the shallower depth on the display such that the content overlaps second content on the display.

16. The apparatus according to claim 1, further comprising:
a communication unit configured to communicate with an external device,
wherein the user input circuit receives the user command from the external device through the communication unit.

17. The apparatus according to claim 16, wherein the user input circuit includes a gesture recognition circuit configured to recognize the gesture of the user detected by an input unit, and the display control circuit is configured to modify scrolling of the content based on the gesture of the user.

18. The apparatus according to claim 6, further comprising:
a content selection unit configured to select the content being scrolled based on the gesture of the user.

19. A method comprising:
receiving a command from the user; and
modifying, using a processor, scrolling of content being automatically scrolled in a first direction based on the command from the user.

20. A non-transitory computer readable medium encoded with computer readable instructions that, when performed by a processor, cause the processor to perform the method according to claim 19.
